(19) United States
(12) Patent Application Publication
(10) Pub. No.: US 2017/0254289 A1
(43) Pub. Date: Sep. 7, 2017

(54) GALLERYLESS PISTON WITH OIL DRAIN FEATURES

(71) Applicant: FEDERAL-MOGUL LLC, Southfield, MI (US)

(72) Inventors: Michael Weinenger, Southfield, MI (US); Jeffrey L. Riffe, Troy, MI (US)

(21) Appl. No.: 15/448,512

(22) Filed: Mar. 2, 2017

Related U.S. Application Data
(60) Provisional application No. 62/304,501, filed on Mar. 7, 2016.

(51) Int. Cl. F02F 3/20

(52) U.S. Cl. CPC F02F 3/20; F02F 2200/06; F02F 2200/04

(57) ABSTRACT

A galleryless steel piston for an internal combustion engine is provided. The piston comprises an exposed undercrown surface, a ring belt with ring grooves, pin bosses, skirt panels, and struts. The piston further includes an inner undercrown region and outer pockets extending along the undercrown surface. The inner undercrown region is surrounded by the skirt panels, the struts, and the pin bosses, and each outer pocket is surrounded by a portion of the ring belt, one of the pin bosses, and two of the struts. The piston includes a plurality of oil slots extending through the back wall of one of the ring grooves, typically the third ring groove, to the inner undercrown region and/or the outer pockets to allow drainage of cooling oil. Each oil slot typically has a diameter ranging from 30% to 100% of an axial width of the ring groove.

### CROSS-REFERENCE TO RELATED APPLICATIONS

This U.S. utility patent application claims priority to U.S. provisional patent application No. 62/304,501, filed Mar. 7, 2016, the contents of which is incorporated herein by reference in its entirety.

### BACKGROUND OF THE INVENTION

1. Technical Field

This invention relates generally to pistons for internal combustion engines, and methods of manufacturing the pistons.

2. Related Art

Engine manufacturers are encountering increasing demands to improve engine efficiencies and performance, including, but not limited to, improving fuel economy, reducing oil consumption, improving fuel systems, increasing compression loads and operating temperatures within the cylinder bores, reducing heat loss through the piston, improving lubrication of component parts, decreasing engine weight and making engines more compact, while at the same time decreasing the costs associated with manufacture.

While desirable to increase the compression load and operation temperature within the combustion chamber, it remains necessary to maintain the temperature of the piston within workable limits. Also, achieving an increase in the compression load and operation temperature comes with a tradeoff in that these desirable “increases” limit the degree to which the piston compression height, and thus, overall piston size and mass can be decreased. This is particularly troublesome with typical piston constructions having a closed or partially closed cooling gallery to reduce the operating temperature of the piston. The cost to manufacture pistons having upper and lower parts joined together along a bond joint to form the closed or partially closed cooling gallery is generally increased due to the joining process used to bond the upper and lower parts together. Further, the degree to which the engine weight can be reduced is impacted by the need to make the aforementioned “cooling gallery” pistons from steel so they can withstand the increase in mechanical and thermal loads imposed on the piston.

Recently, single piece steel pistons without a cooling gallery have been developed and can be referred to as “galleryless” pistons. Such pistons provide for reduced weight, reduced manufacturing costs, and reduced compression height. The galleryless pistons are either spray cooled by a cooling oil nozzle, lightly sprayed for lubrication only, or are not sprayed with any oil. Due to the absence of the cooling gallery, such pistons typically experience higher temperatures than pistons with a conventional cooling gallery. High temperatures can cause oxidation or overheating of an upper combustion surface of the steel piston, which can then cause successive piston cracking and engine failures. High temperatures can also cause oil degradation along an undercrown area of the piston, for example underneath a combustion bowl where the cooling or lubrication oil is sprayed. Another potential problem arising due to high temperatures is that the cooling oil can create a thick layer of carbon in the area where the cooling or lubrication oil is in contact with the piston undercrown. This carbon layer can cause overheating of the piston with potential cracking and engine failure.

### SUMMARY OF THE INVENTION

One aspect of the invention provides a piston for an internal combustion engine. The piston comprises an upper wall including an undercrown surface exposed from an underside of the piston, and a ring belt depending from the upper wall and extending circumferentially around a center axis of the piston. The ring belt includes a plurality of ring grooves extending circumferentially around the center axis and each formed by an upper wall and a lower wall spaced from one another by a back wall. A pair of pin bosses depends from the upper wall, and a pair of skirt panels depends from the ring belt and are coupled to the pin bosses by struts. The piston further includes an inner undercrown region extending along the undercrown surface, and the inner undercrown region is surrounded by the skirt panels, the struts, and the pin bosses. A pair of outer pockets extends along the undercrown surface, and each outer pocket is surrounded by a portion of the ring belt, one of the pin bosses, and the struts coupling the one pin boss to the skirt panels. At least one of the ring grooves includes at least one oil slot extending through the back wall to the inner undercrown region and/or at least one of the outer pockets of the piston.

Another aspect of the invention provides a method of manufacturing a piston. The method includes providing a body including an upper wall, the upper wall including an undercrown surface exposed from an underside of the piston, a ring belt depending from the upper wall and extending circumferentially around a center axis of the piston, the ring belt including a plurality of ring grooves extending circumferentially around the center axis and each formed by an uppermost wall and a lower wall spaced from one another by a back wall, a pair of pin bosses depending from the upper wall, a pair of skirt panels depending from the ring belt and coupled to the pin bosses by struts, an inner undercrown region extending along the undercrown surface and surrounded by the skirt panels and the struts and the pin bosses, a pair of outer pockets extending along the undercrown surface, each outer pocket being surrounded by a portion of the ring belt and one of the pin bosses and the struts coupling the one pin boss to the skirt panels. The method further includes forming at least one oil slot extending through the back wall of at least one of the ring grooves to the inner undercrown region and/or at least one of the outer pockets.

### BRIEF DESCRIPTION OF THE DRAWINGS

These and other aspects, features and advantages of the invention will become more readily appreciated when considered in connection with the following detailed description and accompanying drawings, in which:

FIG. 1 is a bottom view of a galleryless piston which can include oil slots extending through a ring groove according to an example embodiment;

FIG. 2 is a side view of a galleryless piston including oil slots extending through a third ring groove into an inner undercrown according to an example embodiment;

FIG. 2A is an enlarged view of a portion of FIG. 2;

FIG. 3 is a bottom view of the piston of FIG. 2; and

FIG. 4 is a bottom view of a galleryless piston including oil slots extending through a third ring groove into outer pockets according to another example embodiment.

### DETAILED DESCRIPTION OF EXEMPLARY EMBODIMENTS

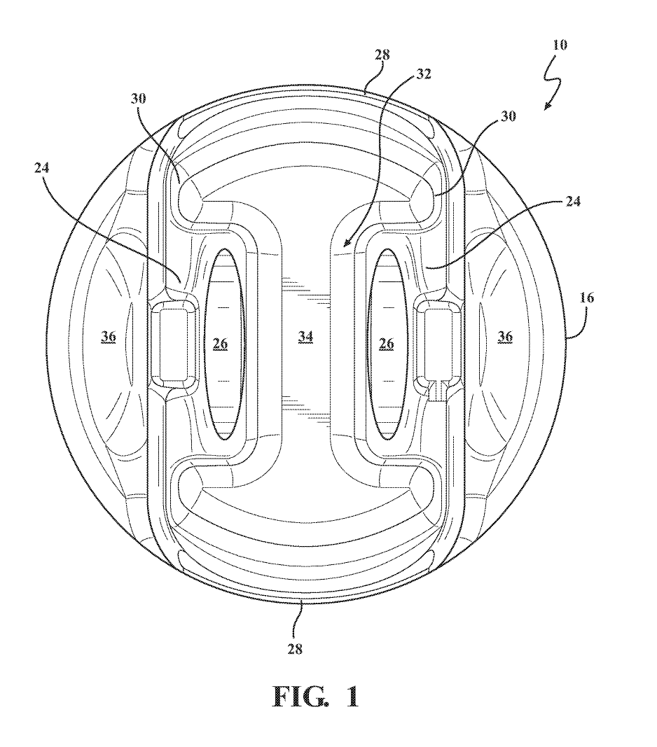

FIGS. 1-4 illustrate views of a piston 10 constructed in accordance with example embodiments of the invention for reciprocating movement in a cylinder bore or chamber (not shown) of an internal combustion engine, such as a modern, compact, high performance vehicle engine, for example. The piston 10 has a reduced weight and operates at a reduced temperature during operation in an internal combustion engine, which contributes to improved thermal efficiency, fuel consumption, and performance of the engine. The piston 10 is also free of a closed cooling gallery which contributes to the reduced weight and related costs, relative to pistons including a closed cooling gallery.

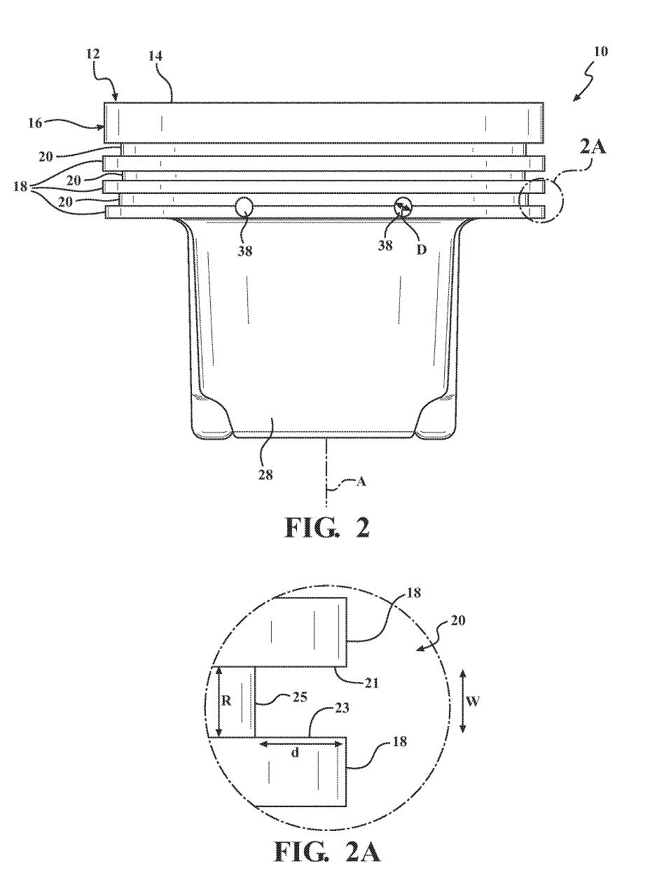

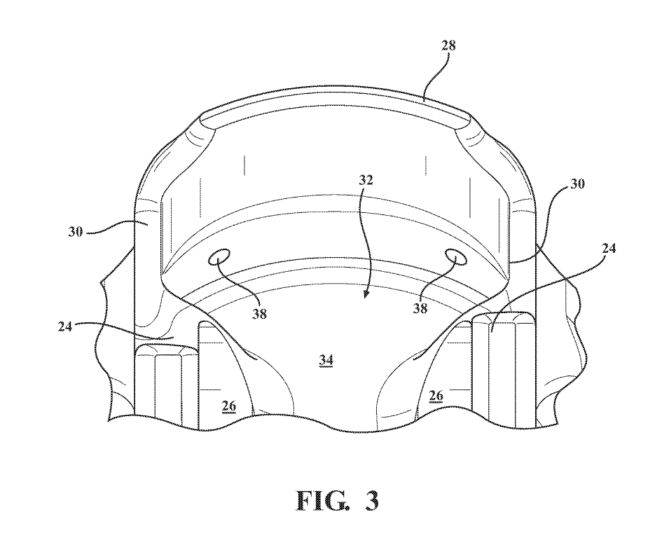

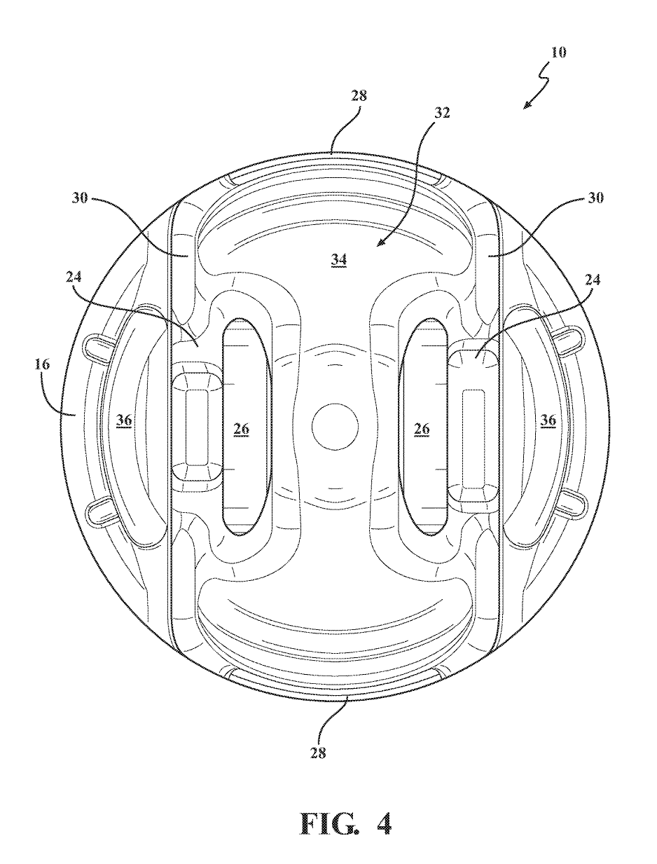

As shown in the Figures, the piston 10 has a monolithic body formed from a single piece of metal material, such as steel. The monolithic body can be formed by machining, forging or casting, with possible finish machining performed thereafter, if desired, to complete construction. Accordingly, the piston 10 does not have a plurality of parts joined together, such as upper and lower parts joined to one another, which is commonplace with pistons having enclosed or partially enclosed cooling galleries bounded or partially bounded by a cooling gallery floor. To the contrary, the piston 10 is “galleryless” in that it does not have a cooling gallery floor or other features bounding or partially bounding a cooling gallery. A bottom view of the galleryless piston 10 is shown in FIG. 1, side and bottom views of the galleryless piston 10 according to another embodiment are shown in FIGS. 2 and 3; and a bottom view of the galleryless piston according to yet another embodiment is shown in FIG. 4.

The body portion, being made of steel or another metal, is strong and durable to meet the high performance demands, i.e. increased temperature and compression loads, of modern day high performance internal combustion engines. The steel material used to construct the body can be an alloy such as the SAE 4140 grade or different, depending on the requirements of the piston 10 in the particular engine application. Due to the piston 10 being galleryless, the weight and compression height of the piston 10 is minimized, thereby allowing an engine in which the piston 10 is deployed to achieve a reduced weight and to be made more compact. Further yet, even though the piston 10 is galleryless, the piston 10 can be sufficiently cooled during use to withstand the most severe operating temperatures.

The body portion of the piston 10 has an upper head or top section providing an upper wall 12. The upper wall 12 includes an upper combustion surface 14 that is directly exposed to combustion gasses within the cylinder bore of the internal combustion engine. In the example embodiment, the upper combustion surface 14 forms a combustion bowl, or a non-planar, concave, or undulating surface around a center axis A.

A ring belt 16 depends from the upper wall 12 and extends circumferentially along an outer diameter of the piston 10. The ring belt 16 includes a plurality of lands 18 separated from one another by ring grooves 20. As best shown in FIG. 2A, each ring groove 20 is formed between an upper wall 21 and a lower wall 23 spaced from one another by a back wall 25. The back wall 25 extends generally parallel to or longitudinally along the center axis A of the piston 10, and the upper and lower walls 21, 23 extend perpendicular or at an angle to the center axis A. The ring grooves 20 can have various different dimensions, but in the example embodiments, the back wall 25 of each ring groove 20 has a length 1 which is a fraction of the length of the piston 10, and the back wall 25 of each ring groove 20 is located distance d from the adjacent lands 18. The distance d of the ring groove 20 is a fraction of the diameter of the piston 10. The length 1 and distance d of the back walls 25 from the adjacent lands 18 of the piston 10 is typically constant around the entire circumference of the piston 10. In addition, each ring groove 20 has an axial width w extending from the upper wall 21 to the lower wall 23, as shown in FIG. 2A, which may be the same as the length 1 of the back wall 25, or different. The piston 10 of the example embodiments includes three ring grooves 20, but the piston 10 could alternatively include another number of ring grooves 20.

The piston 10 further includes a pair of pin bosses 24 depending generally from an undercrown surface 32, inwardly of the ring belt 16. The pin bosses 24 and providing a pair of laterally spaced pin bores 26 which are vertically spaced from the undercrown surface 32. The piston 10 also includes a pair of skirt panels 28 depending from the ring belt 16 and located diametrically opposite one another. The skirt panels 28 are coupled to the pin bosses 24 by struts 30.

The undercrown surface 32 of the piston 10 is formed on an underside of the upper wall 12, directly opposite the upper combustion surface 14 and radially inwardly of the ring belt 16. The undercrown surface 32 is preferably located at a minimum distance from the combustion bowl and is substantially the surface on the direct opposite side from the combustion bowl. The undercrown surface 32 is defined here to be the surface that is visible, excluding any pin bores 26, when observing the piston 10 straight on from the bottom. The undercrown surface 32 is generally form fitting to the combustion bowl of the upper combustion surface 14. The undercrown surface 32 is also openly exposed, as viewed from an underside of the piston 10, and it is not bounded by an enclosed or partially enclosed cooling gallery, or any other features tending to retain oil or a cooling fluid near the undercrown surface 32.

The undercrown surface 32 of the piston 10 has greater a total surface area (3-dimensional area following the contour of the surface) and a greater projected surface area (2-dimensional area, planar, as seen in plan view) than comparative pistons having a closed or partially closed cooling gallery. This open region along the underside of the piston 10 provides direct access to oil splashing or being sprayed from within the crankcase directly onto the undercrown surface 32, thereby allowing the entire undercrown surface 32 to be splashed directly by oil from within the crankcase, while also allowing the oil to freely splash about the wrist pin (not shown), and further, significantly reduce the weight of the piston 10. Accordingly, although not having a typical closed or partially closed cooling gallery, the generally open configuration of the galleryless piston 10 allows optimal cooling of the undercrown surface 32 and lubrication to the wrist pin joint within the pin bores 26, while at the same time reducing oil residence time on the surfaces near the combustion bowl, which is the time in which a volume of oil remains on the surface. The reduced residence time can reduce unwanted build-up of coked oil, such as can occur in pistons having a closed or substantially closed cooling gallery. As such, the piston 10 can remain “clean” over extended use, thereby allowing it to remain substantially free of build-up.

The undercrown surface 32 of the piston 10 of the example embodiment is provided by several regions of the piston 10, including an inner undercrown region 34 and outer pockets 36, which are best shown in FIG. 1. A first portion of the undercrown surface 32 located at the center axis A is provided by the inner undercrown region 34. The inner undercrown region 34 is surrounded by the pin bosses 24, skirt panels 28, and the struts 30. The 2-dimensional and 3-dimensional surface area of the undercrown surface 32 provided by the inner undercrown region 34 is typically maximized so that cooling caused by oil splashing or being sprayed upwardly from the crankcase against the exposed surface can be enhanced, thereby lending to exceptional cooling of the piston 10. In the example embodiments, the undercrown surface 32 of the inner undercrown region 34 is concave, when viewed from the bottom, such that oil can be channeled during reciprocation of the piston 10 from one side of the piston 10 to the opposite side of the piston 10, thereby acting to further enhance cooling of the piston 10.

A second region of the undercrown surface 32 is provided by the outer pockets 36 which are located outwardly of the pin bosses 24. Each outer pocket 36 is surrounded by one of the pin bosses 24, portions of the struts 30 connecting the one pin boss 24 to the skirt panels 28, and a portion of the ring belt 16.

To improve cooling of the inner undercrown region 34 and/or the outer pockets 36 and thus reduce the overall temperature of the piston 10 during operation, at least one oil slot 38 extends through the back wall 25 of at least one of the ring grooves 20, as shown in FIGS. 2-4. The oil slot(s) 38 can extend radially through the back wall 25. The oil slot(s) 38 could also extend through the back wall 25 parallel or perpendicular to the axis of the pin bore 26 such that the axis through the oil slot(s) 38 does not pass through the center axis A of the piston 10.

Each oil slot 38 is located above one of the skirt panels 28 and/or above one of the pin bosses 24. According to one embodiment, the oil slots 38 allow drainage of cooling oil from the ring groove 20 to the inner undercrown region 3. According to another embodiment, the oil slots 38 allow drainage of cooling oil from the ring groove 20 to at least one of the outer pockets 36 of the piston 10. Thus, in this embodiment, the drained cooling oil functions as a source of cooling oil to at least one of the outer pockets 36 and assists in cooling of the at least one outer pocket 36, which tends to lack cooling oil. As indicated above, the additional cooling oil provided to the inner undercrown region 34 and/or outer pockets 36 assists in cooling and thus reduces the overall temperature of the piston 10 during operation.

In the piston 10 of the example embodiment of FIGS. 2 and 3, the piston includes four oil slots 28, and two oil slots 38 are located in the third ring groove 20 above each skirt panel 28. In the embodiment of FIG. 4, the piston includes four oil slots, and two oil slots 38 are located in the third ring groove 20 above each pin boss 24. The oil slots 38 could be located in the third ring groove 20 above the skirt panels 28 and above the pin bosses 24. The oil slots 38 could alternatively be located in another one of the ring grooves 20, or in more than one ring groove 20. Also, the number of oil slots 38, as well as the location in the oil slots 38 around the circumference of the piston 10 can vary.

The oil slots 38 can be formed in the piston 10 according to various methods. In the example embodiment of FIGS. 2 and 3, the oil slots 38 are drilled into the third ring groove 20 after casting the monolithic body. In the example embodiment of FIG. 4, the oil slots 38 are forged in the monolithic body.

Each oil slot 38 typically has a diameter D ranging from 30 to 100% of the axial width w of the ring groove 20 in which the oil slot 38 is formed. If the oil slot 38 is not circular-shaped, then the oil slot 38 has a length and width each ranging from 30 to 200% of the axial width of the groove. However, the dimensions of the oil slots 38 can vary. Each oil slot 38 also extends through the entire thickness of the piston 10 extending from the back wall 25 of the ring groove 20 to one of the outer pockets 36 and/or the inner undercrown region 34. Thus, each oil slot 38 provides an opening to one of the outer pockets 36 and/or to the inner undercrown region 34, which allows oil to drain from the oil slot 38.

The piston 10 designed according to the present invention is able to achieve improved cooling of the inner undercrown region 34 and/or the outer pockets 36, compared to galleryless pistons without the oil slot 38 in the ring belt 16, by allowing for an increase in drainage of oil away from the ring grooves 20 and into the inner undercrown region 34 and/or into at least one of the outer pockets 38.

Another aspect of the invention provides a method of manufacturing the galleryless piston 10 for use in the internal combustion engine. The body portion of the piston 10, which is typically formed of steel, can be manufactured according to various different methods, such as forging or casting. The body portion of the galleryless piston 10 can also comprise various different designs, and examples of the possible designs are shown in FIGS. 1-4.

The method further includes providing at least one of the oil slots 38 in at least one of the ring grooves 20 of the ring belt 16. The oil slots 38 can be formed by drilling into the ring belt 16 after casting the monolithic body portion, or by forging or casting with the monolithic body portion of the piston 10. However, the oil slots 38 could be formed by other methods.

Many modifications and variations of the present invention are possible in light of the above teachings and may be practiced otherwise than as specifically described while within the scope of the invention. It is also contemplated that all features of all claims and of all embodiments can be combined with each other, so long as such combinations would not contradict one another.

1. A piston, comprising:
an upper wall including an undercrown surface exposed from an underside of said piston,
a ring belt depending from said upper wall and extending circumferentially around a center axis of said piston,
said ring belt including a plurality of ring grooves extending circumferentially around said center axis and each formed by an upper wall and a lower wall spaced from one another by a back wall,
a pair of pin bosses depending from said upper wall,
a pair of skirt panels depending from said ring belt and coupled to said pin bosses by struts,
an inner undercrown region extending along said undercrown surface and surrounded by said skirt panels and said struts and said pin bosses,
a pair of outer pockets extending along said undercrown surface,
each outer pocket being surrounded by a portion of said ring belt and one of said pin bosses and said struts coupling said one pin boss to said skirt panels, and
at least one of said ring grooves including at least one oil slot extending through said back wall to said inner undercrown region and/or at least one of said outer pockets of said piston.

2. The piston of claim 1, wherein each of said ring grooves has an axial width extending from said upper wall to said lower wall, and each one of said oil slots has a diameter ranging from 30% to 100% of said axial width of said ring groove.

3. The piston of claim 1, wherein each of said ring grooves has an axial width extending from said upper wall to said lower wall, and each one of said oil slots has a length and width each ranging from 30% to 200% of said axial width of said ring groove.

4. The piston of claim 1, wherein said ring grooves of said ring belt include a first ring groove and a second ring groove and a third ring groove, said first ring groove and said second ring groove and said third ring groove are the only ring grooves present in said piston, and said third ring groove includes a plurality of said oil slots.

5. The piston of claim 4 including only four of said oil slots, and two of said oil slots extend through said third ring groove above each of said skirt panels.

6. The piston of claim 4 including only four of said oil slots, and two of said oil slots extend through said third ring groove above each of said pin bosses.

7. The piston of claim 1, wherein said at least one oil slot extends from said ring groove to said inner undercrown region and/or to at least one of said outer pockets.

8. The piston of claim 1 including a plurality of said oil slots in one of said ring grooves.

9. The piston of claim 1, wherein said back wall of each one of said ring grooves has a length extending from said uppermost wall to said lowermost wall, said length of said back wall is constant around a circumference of said piston, said back wall of each one of said ring grooves is located a distance radially from adjacent lands of said ring belt, and said distance is constant around said circumference of said piston.

10. The piston of claim 1 including a body portion formed of a single piece of steel material, said body portion including said upper wall, said ring belt, said pin bosses, and said skirt panels.

11. The piston of claim 1, wherein said undercrown surface is not bounded by an enclosed or partially enclosed cooling gallery or any other feature tending to retain fluid.

12. The piston of claim 1, wherein said inner undercrown region is located at said center axis and is surrounded by said pin bosses and said skirt panels and said struts, and said outer pockets are located outwardly of said pin bosses.

13. The piston of claim 1 including a body portion formed of a single piece of steel material,
said body does not have a cooling gallery floor or other features bounding or partially bounding a cooling gallery,
said body includes said upper wall presenting an upper combustion surface,
said upper combustion surface is a non-planar surface around said center axis,
said ring belt extends around a circumference of said piston,
said ring belt includes a plurality of lands spacing said ring grooves from one another,
said pin bosses are disposed inwardly of said ring belt and provide a pair of laterally spaced pin bores surrounding a pin bore axis and spaced longitudinally from said undercrown surface,
said pair of skirt panels are located diametrically opposite one another,
said undercrown surface is disposed radially inwardly of said ring belt,
a first portion of said undercrown surface is provided by said inner undercrown region and a second portion of said undercrown surface is provided by said outer pockets,
said inner undercrown region is located at said center axis and is surrounded by said pin bosses and said skirt panels and said struts,
said undercrown surface located in said inner undercrown region is concave when viewed from said underside of said piston,
said outer pockets are located outwardly of said pin bosses,
said ring grooves include a first ring groove and a second ring groove and a third ring groove,
said first ring groove and said second ring groove and said third ring groove are the only ring grooves present in said piston,
said first ring groove is disposed closest to said upper combustion surface and said third ring groove is disposed farthest from said combustion surface,
said back walls of said ring grooves extend parallel and longitudinally along said center axis of said piston,
said uppermost and lower walls of said ring grooves extend perpendicular or at an angle to said center axis of said piston,
said back wall of each one of said ring grooves has a length extending from said uppermost wall to said lowermost wall and parallel to said center axis of said piston,
said length of each one of said back walls is constant around said circumference of said piston,
said back wall of each one of said ring grooves is located a distance radially from said adjacent lands,
said distance is constant around said circumference of said piston,
each of said ring grooves has an axial width extending from said upper wall to said lower wall,
said third ring groove of said ring belt includes a plurality of said oil slots extending through said back wall,
said third ring groove is the only one of said ring grooves including said oil slots,
said oil slots are located above at least one of said skirt panels and/or above at least one of said pin bosses,
said oil slots extend from said third ring groove to said inner undercrown region and/or to at least one of said outer pockets, and
each one of said oil slots has a diameter ranging from 30% to 100% of said axial width of said third ring groove.

14. The piston of claim 13 including only four of said oil slots, two of said oil slots extend through said third ring groove above each of said skirt panels, and each of said oil slots extend from said third ring groove to said inner undercrown region

15. The piston of claim 13 including only four of said oil slots, two of said oil slots extend through said third ring groove above each of said pin bosses, and each of said oil slots extend from said third ring groove to said outer pockets.

16. A method of manufacturing a piston, comprising the steps of:
providing a body including an upper wall, the upper wall including an undercrown surface exposed from an underside of the piston, a ring belt depending from the upper wall and extending circumferentially around a center axis of the piston, the ring belt including a plurality of ring grooves extending circumferentially around the center axis and each formed by an uppermost wall and a lower wall spaced from one another by a back wall, a pair of pin bosses depending from the upper wall, a pair of skirt panels depending from the ring belt and coupled to the pin bosses by struts, an inner undercrown region extending along the undercrown surface and surrounded by the skirt panels and the struts and the pin bosses, a pair of outer pockets extending along the undercrown surface, each outer pocket being surrounded by a portion of the ring belt and one of the pin bosses and the struts coupling the one pin boss to the skirt panels, and
forming at least one oil slot extending through the back wall of at least one of the ring grooves to the inner undercrown region and/or at least one of the outer pockets.

17. The method of claim 16, wherein the step of forming the at least one oil slot includes drilling into the ring belt.

18. The method of claim 16, wherein the body is a single piece of material, and the step of providing the body includes machining, forging, and/or casting the body.

19. The method of claim 18, wherein the step of providing the body includes forging or casting, and the step of forming the at least one oil slot occurs during the forging or casting.

20. The method of claim 16, wherein the ring grooves of the ring belt include a first ring groove and a second ring groove and a third ring groove, the first ring groove and the second ring groove and the third ring groove are the only ring grooves present in the piston, and the third ring groove includes the oil slot.
